(19) United States
(12) Patent Application Publication
(10) Pub. No.: US 2013/0116850 A1
(43) Pub. Date: May 9, 2013

(54) GENERATING AND STORING ENERGY BY MOVING OBJECTS

(71) Applicants: Peter J. Blatner, Wheaton, IL (US); Douglas S. Brown, Charlotte, NC (US); Phillip H. Chung, Roswell, GA (US); John F. Kelley, Clarkesville, GA (US)

(72) Inventors: Peter J. Blatner, Wheaton, IL (US); Douglas S. Brown, Charlotte, NC (US); Phillip H. Chung, Roswell, GA (US); John F. Kelley, Clarkesville, GA (US)

(73) Assignee: International Business Machines Corporation, Armonk, NY (US)

(21) Appl. No.: 13/292,128

(22) Filed: Nov. 9, 2011

(51) Int. Cl. G06F 1/26; B66F 3/24; F03G 3/00

(52) U.S. Cl. 700/297; 185/32; 185/33; 254/93 R

(57) ABSTRACT

Embodiments of the present invention relate to an approach for moving (e.g., lifting and lowering) objects (e.g., structures, cars, etc.) to generate and store energy to address energy shortage conditions. Specifically, the weight of an object is utilized to accumulate potential energy over a period of time through conversion of a source of energy (e.g. electricity) into potential energy when available power (i.e. supply) from the source of energy exceeds demand (e.g., an energy surplus condition is identified). This potential energy is then converted into another form of energy (e.g. electricity) over a period of time when excess power is needed (e.g., an energy shortage condition is identified).

### TECHNICAL FIELD

In general, embodiments of the present invention provide an approach for storing and generating energy by moving objects. Specifically, the present invention provides a computer-based approach for storing and generating energy by moving (e.g., lifting) objects (e.g., houses, cars, etc.) using lifting mechanisms (e.g., hydraulic piston driven actuators).

### BACKGROUND

As the world becomes more automated, the consumption of energy continues to grow. This trend has led to an increased importance being placed on developing renewable energy sources. Some renewable energy sources may be episodic. For instance, solar cells may only generate electricity when the sun is shining. Similarly, wind turbines many only work when there is wind to drive angular motion. Traditional methods of storing energy (e.g., batteries for storing electricity) for later use may be expensive or/or unwieldy

### SUMMARY

In general, embodiments of the present invention relate to an approach for moving (e.g., lifting and lowering) objects (e.g., structures, cars, etc.) to generate and store energy to address energy shortage conditions. Specifically, the weight of an object is utilized to accumulate potential energy over a period of time through conversion of a source of energy (e.g. electricity) into potential energy when available power (i.e. supply) from the source of energy exceeds demand (e.g., an energy surplus condition is identified). This potential energy is then converted into another form of energy (e.g. electricity) over a period of time when excess power is needed (e.g., an energy shortage condition is identified). In a typical embodiment, a lifting mechanism may lift the object from a first position to a second (e.g., higher) position when the energy surplus condition is present. Then, when the energy shortage condition is present (or just prior to being present), the lifting mechanism may incrementally lower the object back to the first (e.g., lower) position as additional energy is needed. The lowering of the object may result in generation of energy that can be utilized to address the energy shortage condition.

A first aspect of the present invention provides a method for storing and generating energy through the movement of objects, comprising: identifying an energy surplus condition; responsive to the energy surplus condition, moving an object from a first position to a second position using a lifting mechanism; identifying an energy shortage condition; responsive to the energy shortage condition, moving the object from the second position to the first position; generating an amount of energy responsive to the moving of the object from the second position to the first position; and utilizing the amount of energy to address the energy shortage condition.

A second aspect of the present invention provides a system for storing and generating energy through the movement of objects, comprising: a memory medium comprising instructions; a bus coupled to the memory medium; and a processor coupled to the bus that when executing the instructions causes the system to: identify an energy surplus condition; responsive to the energy surplus condition, move an object from a first position to a second position using a lifting mechanism; identify an energy shortage condition; responsive to the energy shortage condition, move the object from the second position to the first position; generate an amount of energy responsive to the moving of the object from the second position to the first position; and utilize the amount of energy to address the energy shortage condition.

A third aspect of the present invention provides a computer program product for storing and generating energy through the movement of objects, the computer program product comprising a computer readable storage media, and program instructions stored on the computer readable storage media, to: identify an energy surplus condition; responsive to the energy surplus condition, move an object from a first position to a second position using a lifting mechanism; identify an energy shortage condition; responsive to the energy shortage condition, move the object from the second position to the first position; generate an amount of energy responsive to the moving of the object from the second position to the first position; and utilize the amount of energy to address the energy shortage condition.

A fourth aspect of the present invention provides a method for deploying a system for storing and generating energy through the movement of objects, comprising: providing a computer infrastructure being operable to: identify an energy surplus condition; responsive to the energy surplus condition, move an object from a first position to a second position using a lifting mechanism; identify an energy shortage condition; responsive to the energy shortage condition, move the object from the second position to the first position; generate an amount of energy responsive to the moving of the object from the second position to the first position; and utilize the amount of energy to address the energy shortage condition.

A fifth aspect of the present invention provides a lifting mechanism for storing and generating energy through the movement of objects, comprising: a set of actuators for moving an object from a first position to a second position responsive to an energy surplus condition, and for moving the object from the second position to the first position pursuant to an energy shortage condition, wherein movement between the first position and the second position results in generation of an amount of energy; and a controller for controlling the set of actuators, wherein each of the set of actuators comprises: a hydraulic cylinder; a manifold coupled to the hydraulic cylinder; a valve coupled to the manifold for controlling the manifold and the hydraulic cylinder; a set of pressure transducers for measuring a pressure in a respective one of the set of actuators; and a magnetic position sensor for determining a position of the set of hydraulic cylinders to determine a movement of the object.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system diagram according to an embodiment of the present invention.

FIG. 3 depicts an illustrative embodiment according to an embodiment of the present invention.

FIG. 4 depicts another illustrative embodiment according to the present invention.

FIG. 5 depicts an illustrative lift according to an embodiment of the present invention.

FIG. 6 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As mentioned above, embodiments of the present invention relate to an approach for moving (e.g., lifting and lowering) objects (e.g., structures, cars, etc.) to generate and store energy to address energy shortage conditions. Specifically, the weight of an object is utilized to accumulate potential energy over a period of time through conversion of a source of energy (e.g. electricity) into potential energy when available power (i.e. supply) from the source of energy exceeds demand (e.g., an energy surplus condition is identified). This potential energy is then converted into another form of energy (e.g. electricity) over a period of time when excess power is needed (e.g., an energy shortage condition is identified). In a typical embodiment, a lifting mechanism may lift the object from a first position to a second (e.g., higher) position when the energy surplus condition is present. Then, when the energy shortage condition is present (or just prior to being present), the lifting mechanism may incrementally lower the object back to the first (e.g., lower) position as additional energy is needed. The lowering of the object may result in generation of energy that can be utilized to address the energy shortage condition.

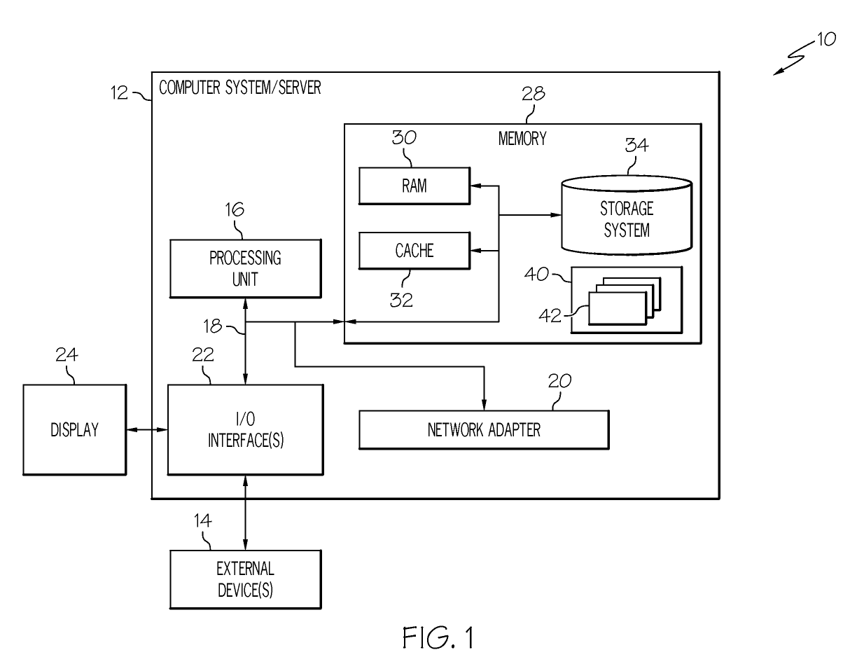

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, mobile devices, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, which perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Energy storage and generation program/utility 40, having a set (at least one) of program modules 42, may be stored in memory 28 by way of example, and not limitation, as well as an operating system, one or more application programs, other program modules, and program data. In general, energy storage and generation program 40 performs the function of the present invention as described herein. For example, will provide energy storage and generation functionality (with data quality assurance and/or sanitization) as discussed below.

Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

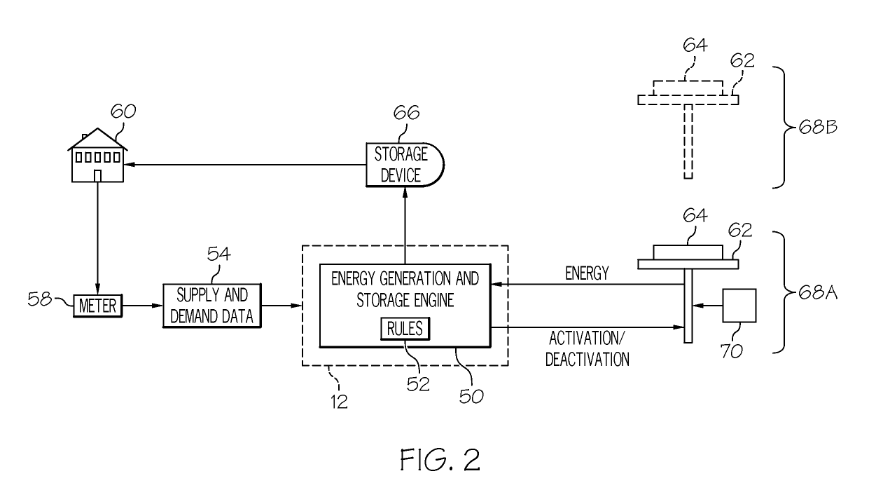

Referring now to FIG. 2, a system diagram according to an embodiment of the present invention is shown. It is understood that the teachings recited herein may be practiced within a networked computing environment (e.g., a cloud computing environment). A stand-alone computer system/server 12 is shown in FIGS. 1 and 2 for illustrative purposes only. In the event the teachings recited herein are practiced in a networked computing environment, each client need not have an energy storage and generation engine (engine 50). Rather engine 50 could be loaded on a server or server-capable device that communicates (e.g., wirelessly) with the clients to provide device protection therefor.

Regardless, as depicted in FIG. 2, engine 50 is shown within computer system/server 12. In general, engine 50 can be implemented as program 40 on computer system 12 of FIG. 1 and can implement the functions recited herein. As further shown, engine 50 (in one embodiment) comprises a rules and/or computational engine that processes a set (at least one) of rules/logic 52 and/or performs computations to provide energy storage and generation hereunder.

Along these lines, engine 50 may perform multiple functions similar to a general-purpose computer using rules/logic 52. Specifically, among other functions, engine 50 may (among other things): identify an energy surplus condition (e.g., from structure/residence 60 via supply and demand data 54 from meter 58 or the like); responsive to the energy surplus condition, move object 64 from first (e.g., lower) position 68A to second (e.g., higher) position 68B using a lifting mechanism 62 (e.g., and/or energy previously stored in storage device 66); identify an energy shortage condition (e.g., from structure/residence 60 via supply and demand data 54 from meter 58 or the like); responsive to the energy shortage condition, move object 64 from second position 68B to first position 68A; generate an amount of energy responsive to the moving of the object from the second position to the first position; optionally store the amount of energy in energy storage device 66 (e.g., a reservoir); and/or utilize the amount of energy to address the energy shortage condition.

It is understood that while an energy surplus condition exists, the surplus energy could be used to lift object 64 to second position 68B from higher position 68A. One possible way of implementing this scenario is to use the surplus energy power, a generator 70 being used to operate the lifting mechanism (e.g., or a motor such as a hydraulic pump motor, an electronic motor driving a gear actuated lifting mechanism such as a rack and pinion mechanism, a pulley drive mechanism utilizing cables, an elevator system wherein the elevator car is used as the object being lifted, etc.) to bring object 64 to second position 68B. In addition, it is understood that object 64 can comprise any object whose weight meets a predetermined threshold (e.g., an object that will have weight sufficient to generate a minimal amount of potential energy when at position 68B). Whether an object has sufficient weight can be based on the amount of energy that was historically needed to address traditional energy shortages. Examples of objects can include (among others) structure 60 itself, an automobile, etc.

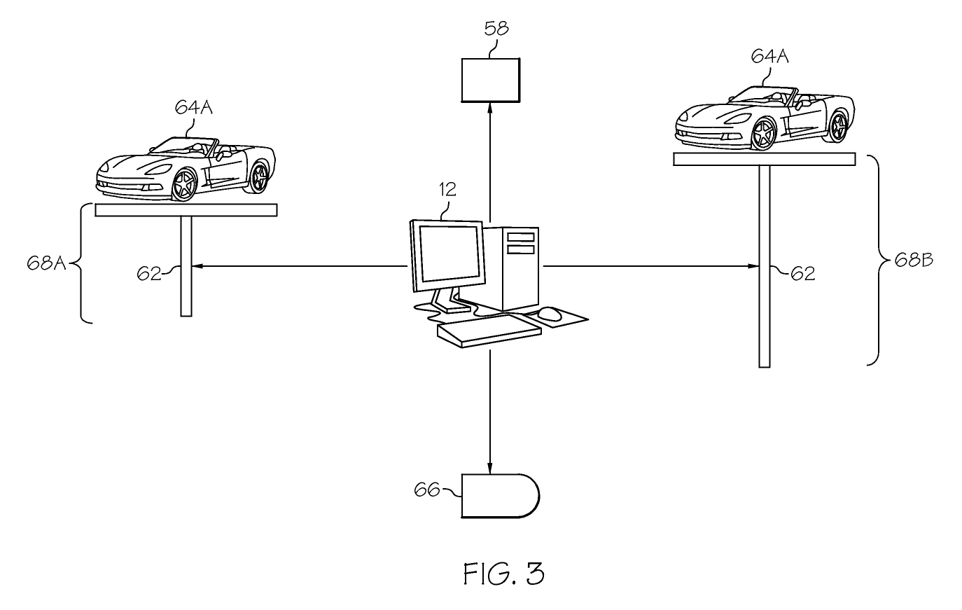

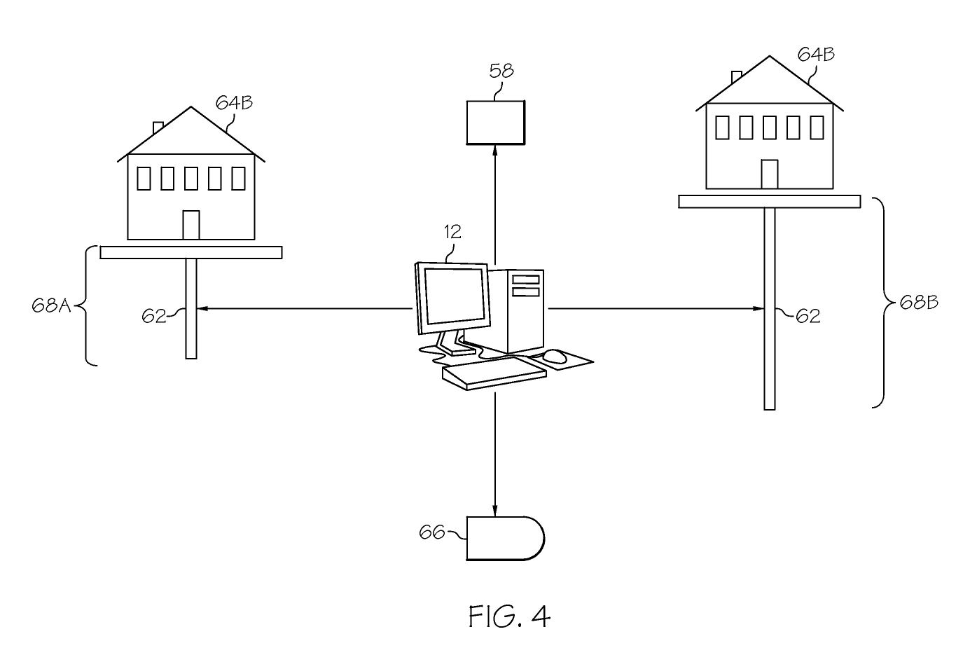

Referring now to FIGS. 3-4, these functions will be described in greater detail. Specifically, FIG. 3 shows that object 64 can be an automobile 64A. As depicted, system 12 (having engine 50 not shown) will receive supply and demand data from meter 58 or the like. System 12 will then cause lifting mechanism 62 to raise and lower automobile 64A between first position 68A and second position 68B. As indicated above, the raising of automobile 64A to second (elevated) portion 68B (in response to an energy surplus condition) results in potential energy that is converted to useable kinetic energy when automobile 64A is later lowered back to first position 68A (in response to an energy shortage condition). This kinetic energy results in an amount of energy that can be stored in storage device 66 and/or used to address the energy shortage condition.

Similarly, FIG. 4 shows that object 64 can be a structure 64B (e.g., the same structure for which an energy shortage was identified, or a separate structure). As depicted, system 12 (having engine 50 not shown) will receive supply and demand data from meter 58 or the like. System 12 will then cause lifting mechanism 62 to raise and lower structure 64B between first position 68A and second position 68B. As indicated above, the raising of structure 64B to second (elevated) position 68B (in response to an energy surplus condition) results in potential energy that is converted to useable kinetic energy when structure 64B is later lowered back to first position 68A (in response to an energy shortage condition). This kinetic energy results in an amount of energy that can be stored in storage device 66 and/or used in addressing the energy shortage condition.

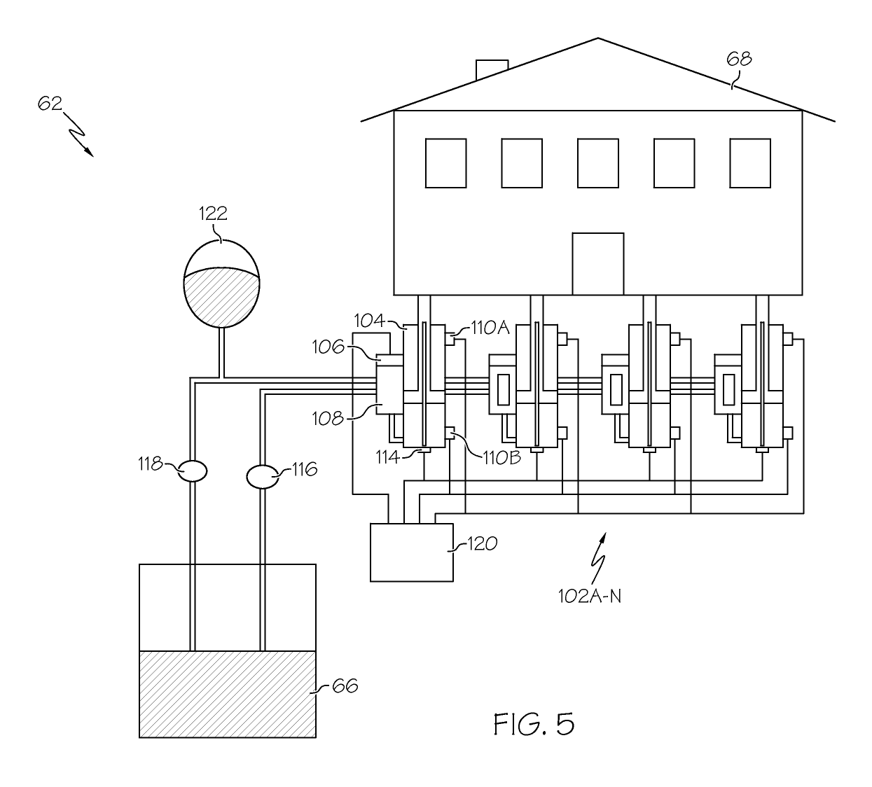

Referring now to FIG. 5, lifting mechanism 62 is shown in greater detail. As depicted, FIG. 5 shows structure 68 (the “object” in this example) being supported by a set of actuators/jacks 102A-N. Although four are shown, any quantity could be provided. Regardless, as described above, set of actuators 102A-N moves object 68 from a first position to a second position responsive to an energy surplus condition, and then moves object 68 from the second position to the first position pursuant to an energy shortage condition. This movement of object 68 results in the generation of an amount of energy that can be stored and/or used to address the energy shortage condition. As further shown, set of actuators 102A-N are controlled by a controller 120, which can receive signals from engine 50 of FIG. 2. Still yet, set of actuators 120A-N each typically comprise: a hydraulic cylinder 104, a manifold 106 coupled to the hydraulic cylinder 104, a valve 106 coupled to the manifold 108 for controlling the manifold 108 and the hydraulic cylinder 104, a set of pressure transducers 110A-B for measuring a pressure in a respective one of the set of actuators, a magnetic position sensor 114 for determining a position of the hydraulic cylinder 104 to determine a movement of object 68. As further shown, FIG. 5 depicts pump 116 and pump/generator 118, accumulator 122 and energy storage device/reservoir 66. Pump/generator 116 can be used to lift object 68 as discussed above (e.g., using previously stored or surplus energy). Then, when object 68 is lowered and the potential energy is converted, an amount of energy will be captured/accumulated by accumulator 122 and transported to, and stored in, storage device 66 via pump 118.

### Illustrative Example

This section will discuss one possible illustrative example for carrying out the teachings recited herein. It is understood that this example is not intended to be exhaustive.

Excess power can drive a low-voltage pump to increase the pressure on the hydraulic lines (or, by means of extensive gearing, apply power directly to a mechanical jack system) which, in turn, raises the object. An alternate solution would be to use the excess power to charge a regular (e.g., car) battery which can, when there is enough charge, briefly drive a more powerful pump or jack motor. When demand exceeds supply, the system is switched into the power-releasing mode, lowering the object and driving a generator (e.g., mechanically or via a turbine system in the hydraulic lines).

The potential “falling weight” energy generated by this method may be significant in long-term vehicle storage facilities (e.g. vehicle impounds, aircraft hangers, urban parking facilities) and cargo container warehouses and shipping yards, where multiple vehicles and jacks/lifts/actuators may be operated. Vehicle lifts may also provide the benefit of creating an additional level of parking space. Shown below are a set of equations that enable the teachings recited herein:

Power (KW)=(Ppressure (Bars)×Qflow (liters/min))+600*(ηeff pump*ηeff gen)

Normal stick construction averages 60 lbs/ft2 or 293 kg/m2.

For a 3000 ft2 (278.7m2) single story home:

3000 ft2*60 lbs/ft2=180,000 lbs

278.7 m2*293 kg/m2=81,659 kg

If a load is divided across (8×) 10 cm hydraulic cylinders, the result is a cylinder pressure of:

81,659 kg/8 cylinders=10,207 kg/cylinder

Acyl=πr2=π*(5 cm)2=π*25=78.54 cm2

As such, the cylinder pressure is:

10,207 kg/78.54 cm2=130 kg/cm2=127.4 bars.

Assuming a lm lift gives a:

Vcyl=Acyl*h=78.54 cm2*100 cm=7854 cm3.

For 8 cylinders the:

Vtotal=7854*8=62,832 cm3

Assuming that the house takes 1 hour to lower the:

Qflow=62,832 cm3/hr=1.0472 liters/min

Using a pump and generator efficiencies of:

0.75=ηeff pump*ηeff gen=0.75*0.75=0.5625

Power=(127.4 bars*1.0472 liters/min)+600*0.5625=0.13 KW/hr

The controller 120 will monitor the level of all the actuators installed and will include a level sensor on the frame of the building to assure that it raises and lowers evenly and in level fashion. Incidentally, this would also help prevent the kind of “settling” damage that is common in houses as foundations sink. The controller 120 provides stability both during raising (storage) and lowering (regeneration).

It is noted that the failure of any given actuator may be immediately sensed (by the monitoring of the level of that actuator) and the controller 120 may immediately use the remaining actuators to evenly distribute the load at the failed actuator's level to assure no structural tension to the frame of the house. Actuators may also contain fail-safe brakes (as in elevators) so that total failure of that actuator may automatically result in freezing the actuator in the current position to prevent sagging. In addition, cross-bracing could add additional stability to assure an even lift. Moreover, lifting pistons could be in hardened tubes with steel rollers to provide additional stability in the case of high winds or severe storms (and the automatic leveling software in the controller would lend dynamic stability).

It is noted that the approach discussed herein need not be not limited to consumer homes (which can weigh 50,000 pounds or greater). High-rise buildings that are already engineered to sit on a limited number of supports (i.e., not on an expanse of foundations sunk deep into the earth) are also eligible for energy storage by lifting the concave supporting pads themselves.

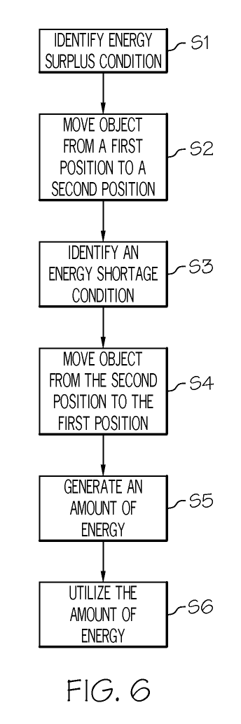

Referring now to FIG. 6, a method flow diagram according to an embodiment of the present invention is shown. In step S1, an energy surplus condition is identified. In step S2, responsive to the energy surplus condition, an object is moved from a first position to a second position using a lifting mechanism. In step S3, an energy shortage condition is identified. In step S4, responsive to the energy shortage condition, the object is moved from the second position to the first position. In step S5, an amount of energy is generated responsive to the moving of the object from the second position to the first position. In step S6, the amount of energy is utilized to address the energy shortage condition.

While shown and described herein as an energy storage and generation solution, it is understood that the invention further provides various alternative embodiments. For example, in one embodiment, the invention provides a computer-readable/useable medium that includes computer program code to enable a computer infrastructure to provide energy storage and generation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide energy storage and generation functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for energy storage and generation. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for storing and generating energy through the movement of objects, comprising:
identifying an energy surplus condition;
responsive to the energy surplus condition, moving an object from a first position to a second position using a lifting mechanism;
identifying an energy shortage condition;
responsive to the energy shortage condition, moving the object from the second position to the first position;
generating an amount of energy responsive to the moving of the object from the second position to the first position; and
utilizing the amount of energy to address the energy shortage condition.

2. The method of claim 1, the method being computer-implemented, and the energy surplus condition and the energy shortage condition being identified by receiving energy supply and demand data in a computer memory medium.

3. The method of claim 1, the second position having a higher elevation than the first position.

4. The method of claim 1, further comprising storing the amount of energy in an energy storage device prior to the utilizing.

5. The method of claim 1, the energy surplus condition resulting in a surplus of energy, the surplus of energy being utilized to move the object from the first position to the second position.

6. The method of claim 5, the surplus of energy being used to power at least one of a generator or a motor being used to operate the lifting mechanism.

7. The method of claim 1, the object comprising at least one of the following: a structure, an automobile, or an object having a weight that meets a predetermined threshold.

8. The method of claim 1, the lifting mechanism comprising:
a set of actuators for moving the object between the first position and the second position; and
a controller for controlling the set of actuators, wherein each of the set of actuators comprises:
a hydraulic cylinder;
a manifold coupled to the hydraulic cylinder;
a valve coupled to the manifold for controlling the manifold and the hydraulic cylinder;
a set of pressure transducers for measuring a pressure in a respective one of the set of actuators; and
a magnetic position sensor for determining a position of the set of hydraulic cylinders to determine a movement of the object.

9. A system for storing and generating energy through the movement of objects, comprising:
a memory medium comprising instructions;
a bus coupled to the memory medium; and
a processor coupled to the bus that when executing the instructions causes the system to:
identify an energy surplus condition;
responsive to the energy surplus condition, move an object from a first position to a second position using a lifting mechanism;
identify an energy shortage condition;
responsive to the energy shortage condition, move the object from the second position to the first position;
generate an amount of energy responsive to the moving of the object from the second position to the first position; and
utilize the amount of energy to address the energy shortage condition.

10. The system of claim 9, the energy surplus condition and the energy shortage condition being identified by receiving energy supply and demand data in the memory medium.

11. The system of claim 9, the second position having a higher elevation than the first position.

12. The system of claim 9, the memory medium further comprising instructions for causing the system to store the amount of energy in an energy storage device prior to the utilizing.

13. The system of claim 9, the energy surplus condition resulting in a surplus of energy, the surplus of energy being utilized to move the object from the first position to the second position.

14. The system of claim 13, the surplus of energy being used to power at least one of a generator or a motor being used to operate the lifting mechanism

15. The system of claim 9, the object comprising at least one of the following: a structure, an automobile, or an object having a weight that meets a predetermined threshold.

16. A computer program product for storing and generating energy through the movement of objects, the computer program product comprising a computer readable storage media, and program instructions stored on the computer readable storage media, to:
identify an energy surplus condition;
responsive to the energy surplus condition, move an object from a first position to a second position using a lifting mechanism;
identify an energy shortage condition;
responsive to the energy shortage condition, move the object from the second position to the first position;
generate an amount of energy responsive to the moving of the object from the second position to the first position; and
utilize the amount of energy to address the energy shortage condition.

17. The computer program product of claim 16, the energy surplus condition and the energy shortage condition being identified by receiving energy supply and demand data in the memory medium.

18. The computer program product of claim 16, the second position having a higher elevation than the first position.

19. The computer program product of claim 16, the computer readable storage media further comprising instructions to store the amount of energy in an energy storage device prior to the utilizing.

20. The computer program product of claim 16, the energy surplus condition resulting in a surplus of energy, the surplus of energy being utilized to move the object from the first position to the second position.

21. The computer program product of claim 20, the surplus of energy being used to power at least one of a generator or a motor being used to operate the lifting mechanism.

22. The computer program product of claim 16, the object comprising at least one of the following: a structure, an automobile, or an object having a weight that meets a predetermined threshold.

23. A method for deploying a system for storing and generating energy through the movement of objects, comprising:
providing a computer infrastructure being operable to:
identify an energy surplus condition;
responsive to the energy surplus condition, move an object from a first position to a second position using a lifting mechanism;
identify an energy shortage condition;
responsive to the energy shortage condition, move the object from the second position to the first position;
generate an amount of energy responsive to the moving of the object from the second position to the first position; and
utilize the amount of energy to address the energy shortage condition.

24. A lifting mechanism for storing and generating energy through the movement of objects energy, comprising:
a set of actuators for moving an object from a first position to a second position responsive to an energy surplus condition, and for moving the object from the second position to the first position pursuant to an energy shortage condition, wherein movement between the first position and the second position results in generation of an amount of energy; and
a controller for controlling the set of actuators, wherein each of the set of actuators comprises:
a hydraulic cylinder;
a manifold coupled to the hydraulic cylinder;
a valve coupled to the manifold for controlling the manifold and the hydraulic cylinder;
a set of pressure transducers for measuring a pressure in a respective one of the set of actuators; and
a magnetic position sensor for determining a position of the set of hydraulic cylinders to determine a movement of the object.

25. The lifting mechanism of claim 24, further comprising:
an accumulator for accumulating energy responsive to the moving of the object between the first position and the second position; and
an energy storage device for storing the amount of energy to address the energy shortage condition.
